(19) United States
(12) Patent Application Publication
(10) Pub. No.: US 2004/0195451 A1
(43) Pub. Date: Oct. 7, 2004

(54) Seat-mounting systems and methods

(76) Inventors: Paul Bentley, Gainesville, TX (US); Adrianus W.N. Ruiter, Denton, TX (US)

Correspondence Address: JOHN S. PRATT, ESQ, KILPATRICK STOCKTON, LLP, 1100 PEACHTREE STREET, ATLANTA, GA, 30309, US

(21) Appl. No.: 10/694,241

(22) Filed: Oct. 27, 2003

Related U.S. Application Data
(60) Provisional application No. 60/456,006, filed on Mar. 18, 2003.

(51) Int. Cl. B64D 11/06

(52) U.S. Cl. 244/118.6

(57) ABSTRACT

Multi-component seating units are detailed. The units are adapted to mount directly to regular aircraft (or similar) seat tracks, as typical economy-class seats do now. The units may include base frames extended beyond the normal seat envelope to permit intersection of the frames with regular seat tracks in orientations other than simply with seats aligned longitudinally with the tracks.

### CROSS-REFERENCE TO RELATED APPLICATION

This application claims the benefit of U.S. Provisional Application No. 60/456,006 filed on Mar. 18, 2003, the contents of which are incorporated herein by reference.

### FIELD OF THE INVENTION

This invention relates to furniture, including seats, and more particularly (although not exclusively) to passenger seating in aircraft or other vessels used for transportation.

### BACKGROUND OF THE INVENTION

Premium-class cabins of, especially, long-haul aircraft increasingly are being outfitted with amenities for travelling passengers. Primary seats for these passengers may, for example, include seat backs reclinable to greater extent than seats placed in economy-class cabins and extendable leg- and foot-rests. Furniture in the form of tables (for work papers or food trays), video monitors, and stowage cabinets additionally may be incorporated into or adjacent such seats. Moreover, in some cases a privacy screen may be associated with each seat.

Existing premium-class furniture typically is provided in palletized arrangements. Stated differently, furniture comprising a particular seating unit for a passenger usually is mounted together on a single pallet. To install the unit, therefore, only the pallet need be mounted to the aircraft floor (either to regular aircraft seat tracks or to special mounting points). However, to withstand dynamic crash loads and meet other governmental regulations, the pallets and their mounting attachments must be sturdy, adding substantial additional weight to the seating units. This extra weight, in turn, increases fuel consumption by the affected aircraft.

### SUMMARY OF THE INVENTION

The present invention avoids any need to use pallets in connection with multi-component vessel seating units. Instead, the units of the invention are adapted to mount directly to regular aircraft (or similar) seat tracks, as typical economy-class seats do now. Thus, utilizing the present invention, multi-component seating units for premium travellers may be provided using only the attachment tracks presently used for simple economy-class seats. Furniture associated with the seats additionally may be certified as regular cabin equipment, avoiding need for qualifying it to the same dynamic load standards as the seats themselves.

To accomplish this result, seating units of the invention may include frames extended beyond the normal seat envelope. This permits intersection of the frames with regular seat tracks in orientations other than simply with primary seats aligned longitudinally with the tracks. Accordingly, the innovative seating units need not be oriented parallel to longitudinal axes of the aircraft or other vessel. Furthermore, because the frames intersect the regular seat tracks, normal fittings may be used to connect them together.

It thus is an optional, non-exclusive object of the present invention to provide multi-component seating units for vessels including, but not limited to, aircraft.

It also is an optional, non-exclusive object of the present invention to provide seating units adapted for direct connection to vessel floors rather than to pallets or other intermediate structures.

It is another optional, non-exclusive object of the present invention to provide seating units that may be oriented differently notwithstanding their direct connection to vessel floors.

Other objects, features, and advantages of the present invention will be apparent to those skilled in the relevant art with reference to the remaining text and drawings of this application.

### BRIEF DESCRIPTION OF THE DRAWINGS

FIG. 1 provides a top plan view of an exemplary arrangement of seating units in, for example, the forward passenger cabin of a Boeing 747-400 aircraft.

FIG. 2 illustrates, via a top plan view, intersection of a seating unit of FIG. 1 with regular seat tracks of a vessel.

FIGS. 3-6 provide additional mounting details for seating units of FIGS. 1 and 2.

FIGS. 7-9 show exemplary arrangements of seating units in selected other existing commercial aircraft.

### DETAILED DESCRIPTION

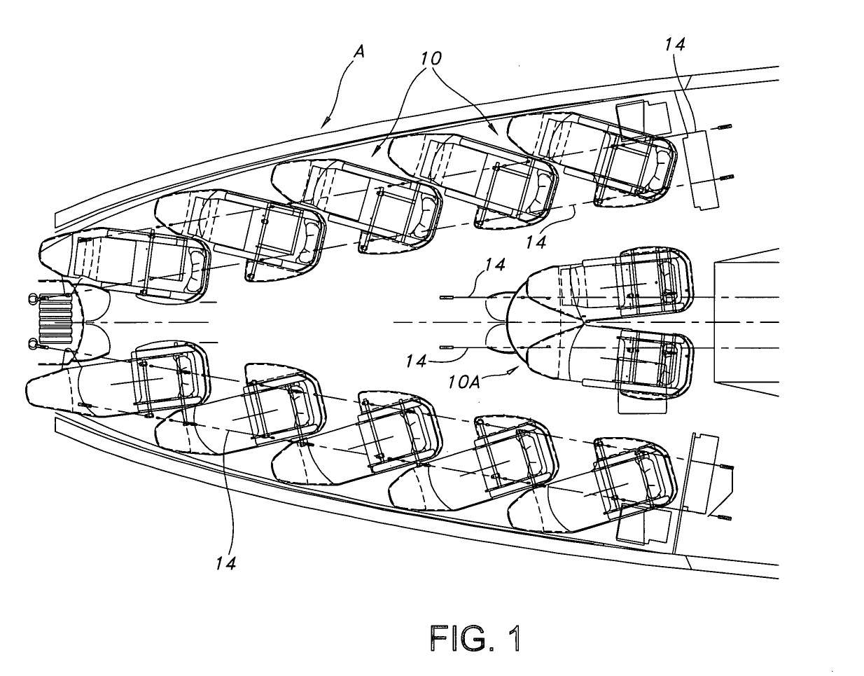

Depicted in FIG. 1 is an example of an arrangement of seating units 10 within an aircraft A, in this instance a Boeing 747-400 plane. Each seating unit 10 is designed to include not only a seat for an occupant, but also ancillary furniture. Such ancillary furniture typically will include at least a table, stowage container, and video monitor, although it need not necessarily do so and may include other or additional components instead.

FIG. 1 also details sets of seat tracks 14 regularly provided in the cabin floor of aircraft A. Each set consists of a pair of parallel tracks 14 to which seating units 10 may be mounted. Detailed in FIG. 1 are three sets of such tracks 14, one surrounding the longitudinal axis of aircraft A and two along the inner fuselage walls. Fewer or greater sets of tracks 14 may exist within any particular aircraft, however.

As illustrated in FIG. 1, none of seating units 10 has its longitudinal axis aligned with tracks 14 to which it is mounted. Instead, each seating unit 10 is offset longitudinally from tracks 14 so that, for example, occupants of seating units 10 positioned along the fuselage walls of aircraft A face outward (i.e. toward the adjacent wall). A dual-seating unit 10A positioned in the central part of the cabin may be oriented differently. However, because FIG. 1 presents only an exemplary arrangement, those skilled in the art will understand that other arrangements of seating units 10 may be, employed. Any particular seating unit 10 may, for example, be oriented inward, so that its occupant faces away from any adjacent wall), or longitudinally aligned with tracks 14.

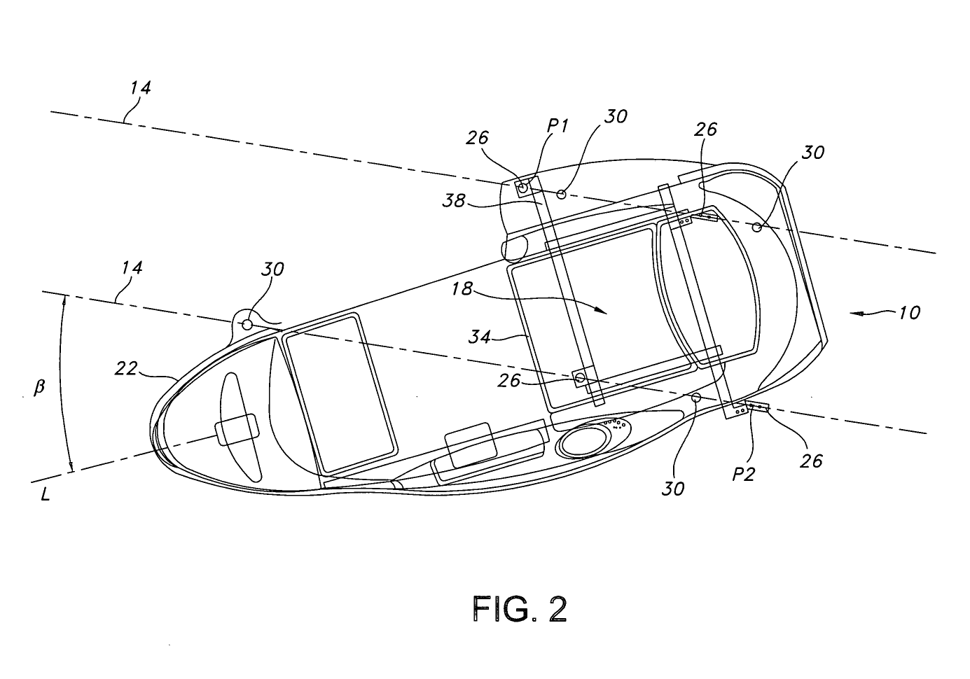

Shown in FIG. 2 are portions of a single seating unit 10 with its (direct) connections to tracks 14. Designated in FIG. 2 as including seat 18 and sleeper suite 22 (which may include any ancillary furniture), unit 10 may attach to tracks 14 at myriad places. These attachments for seat 18 are identified as element 26, while attachments for suite 22 are identified as element 30.

Seat 18 may include main frame 34 and base frame 38, with the former defining the basic envelope of the seat 18. Base frame 38, by contrast, may be extended beyond this envelope so as to intersect a track 14. Two such extensions are depicted in FIG. 2, allowing base frame 38 to intersect tracks 14 at points P1 and P2. Seating unit 10, consequently, need not necessarily have its longitudinal axis L be parallel to a track 14, but instead may be offset an angle β such as shown in FIG. 2.

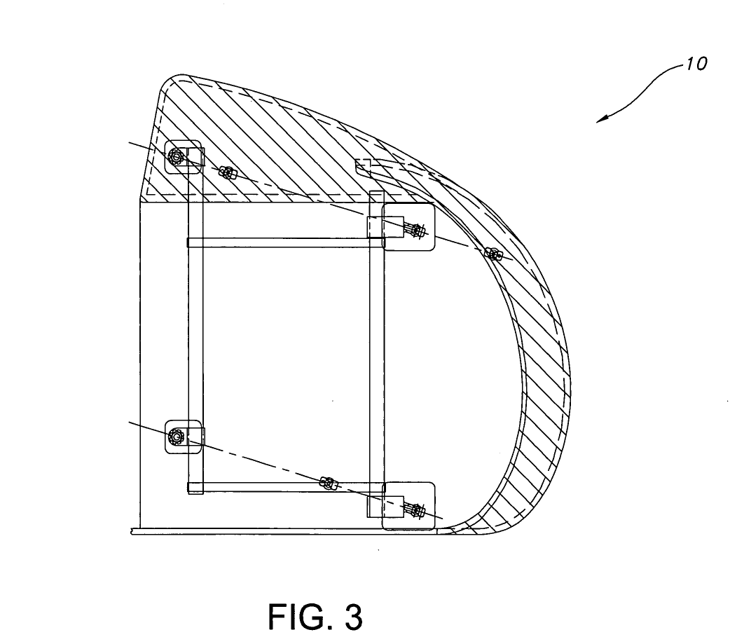

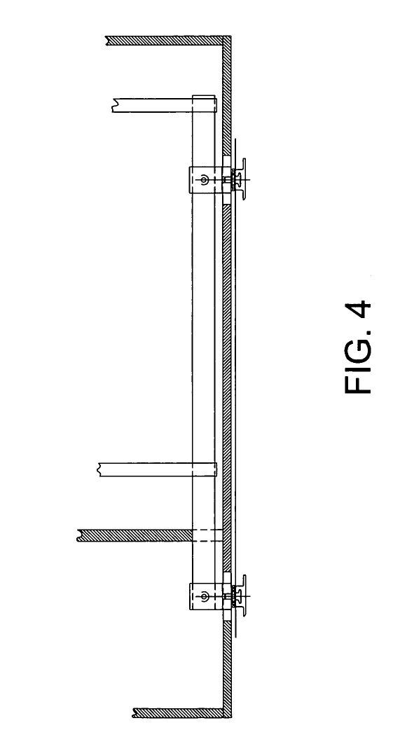

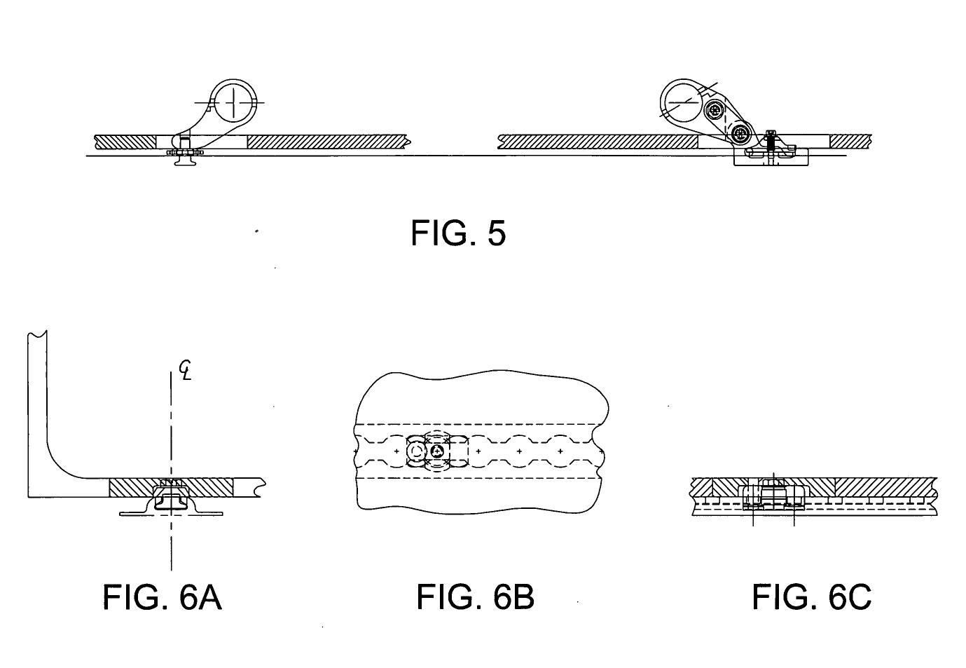

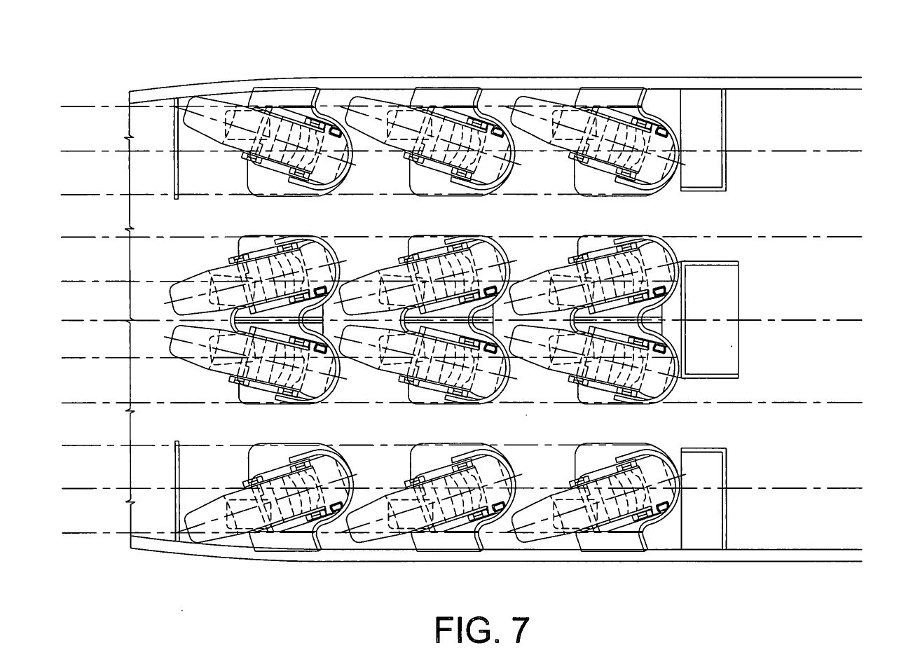

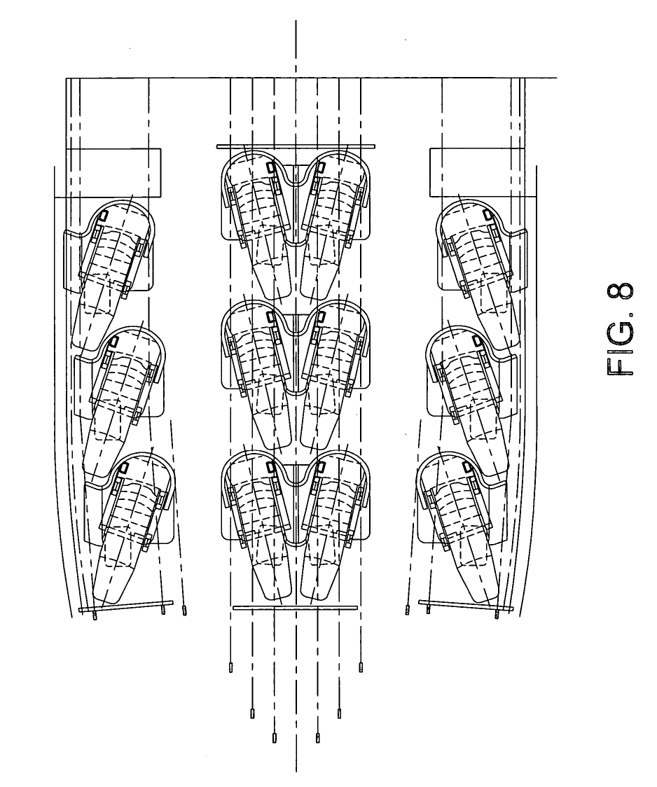

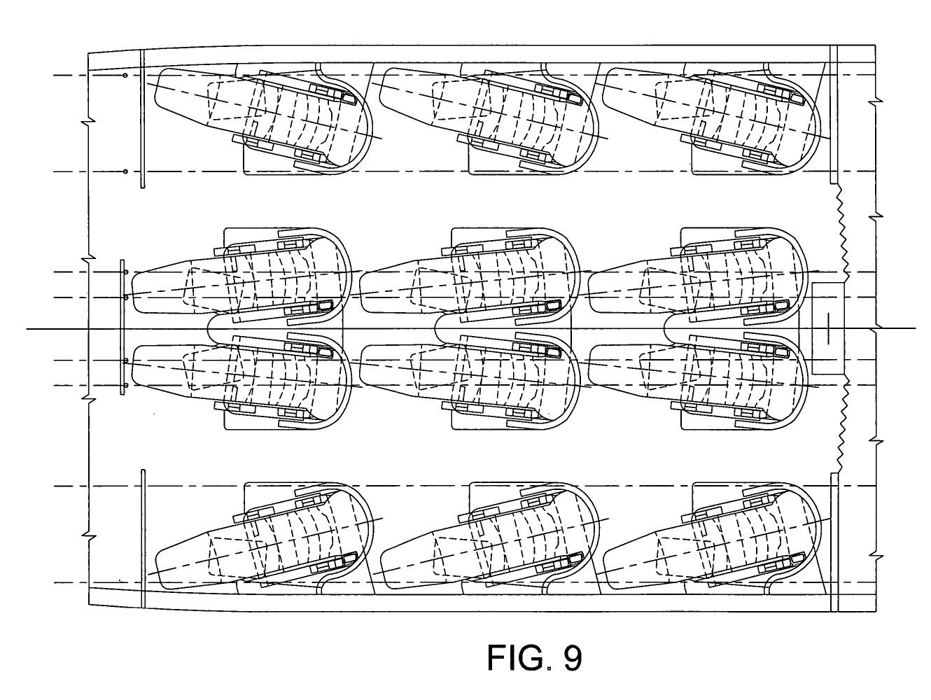

FIGS. 3-6 show other aspects of seating units 10 and connections to tracks 14. FIGS. 7-9, like FIG. 1, depict exemplary arrangements of multiple units 10 within an aircraft. FIG. 7, for example, shows one possible layout of units 10 within an Airbus 330 or 340 aircraft, while FIG. 8 illustrates a sample arrangement within a Boeing 777 aircraft. FIG. 9, finally, shows an example of a seating arrangement within a Boeing 767 plane.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention.

What is claimed is:

1. A passenger seating unit, comprising a seat and ancillary furniture, adapted for mounting directly to a floor of a vessel in which it is located.

2. A passenger seating unit comprising a seat having a base frame, the base frame being extended beyond the envelope of the seat to permit its attachment to a track in a floor of a vessel in which it is located.

3. A passenger seating unit according to claim 2 in which the seat further has a main frame defining the envelope of the seat.

4. A passenger seating unit according to claim 3 in which the base frame includes at least one means for attaching the seat to the track in the floor of the vessel.

5. A passenger seating unit according to claim 4 in which the base frame includes a plurality of means for attaching the seat to the track in the floor of the vessel.

6. A passenger seating unit according to claim 4 in which the seat defines a longitudinal axis, with the longitudinal axis not being parallel to the track in the floor of the vessel when the seat is attached thereto.

7. A passenger seating unit according to claim 6 further comprising a sleeper suite.

8. A passenger seating unit according to claim 6 further comprising ancillary furniture selected from the group consisting of a table, a stowage container, and a video monitor.

9. A method of configuring passenger seating in a vessel, comprising:
a. providing a passenger seating unit comprising a seat having a base frame extended beyond the envelope of the seat; and
b. attaching the base frame directly to the floor of the vessel.

10. A method according to claim 9 in which attaching the base frame directly to the floor of the vessel comprises attaching the base frame to a track in the floor of the vessel.

11. A method according to claim 10 in which the seat defines a longitudinal axis and attaching the base frame to the track in the floor of the vessel comprising attaching the base frame to the track so that the longitudinal axis is not parallel to the track.

12. A vessel in the form of an aircraft in which a plurality of seating units according to claim 1 are mounted.

13. A vessel in the form of an aircraft in which a plurality of seating units according to claim 2 are mounted.
